(19) United States
(12) Patent Application Publication
(10) Pub. No.: US 2026/0185830 A1
(43) Pub. Date: Jul. 2, 2026

(54) CURRENT TOPOGRAPHY DATA CREATION SYSTEM FOR WORK SITE AND CURRENT TOPOGRAPHY DATA CREATION METHOD FOR WORK SITE

(71) Applicant: KOMATSU LTD., Tokyo (JP)

(72) Inventors: Masataka OZAKI, Tokyo (JP); Yoshihiro TAGAWA, Tokyo (JP); Ryota OZAKI, Tokyo (JP)

(73) Assignee: KOMATSU LTD., Tokyo (JP)

(21) Appl. No.: 19/127,125

(22) PCT Filed: Nov. 8, 2023
(86) PCT No.: PCT/JP2023/040222

§ 371 Date: May 4, 2025

(30) Foreign Application Priority Data
Nov. 11, 2022 (JP) 2022-180994

(51) Int. Cl. G01C 15/00; E02F 9/26

(52) U.S. Cl. CPC G01C 15/002; E02F 9/261

(57) ABSTRACT

A current topography data creation system for a work site includes: a current topography data reception unit that receives first current topography data of a work site detected by a three-dimensional sensor included in each of a plurality of work machines; an attribute data reception unit that receives attribute data given to the first current topography data; a current topography data creation unit that creates second current topography data of the work site based on the first current topography data; a priority storage unit that stores priority related to attribute data given to the second current topography data; and an attribute data update unit that, in a case where a plurality of pieces of attribute data of a certain point of the first current topography data is received within a predetermined time, gives attribute data to the point of the second current topography data based on the priority.

### TECHNICAL FIELD

The present disclosure relates to a current topography data creation system for a work site and a current topography data creation method for a work site.

### BACKGROUND ART

In a technical field related to a work machine, a current topography data creation method as disclosed in Patent Literature 1 is known.

### CITATION LIST

### Patent Literature

Patent Literature 1: US 2019/383631

### SUMMARY OF INVENTION

### Technical Problem

A work site such as a mine may include an obstacle or a cliff. In a case where current topography data of a work site is created, there is a demand for appropriately incorporating the situation of the work site into the current topography data.

An object of the present disclosure is to appropriately incorporate a situation of a work site into current topography data.

### Solution to Problem

According to the present disclosure, provided is a current topography data creation system for a work site including: a current topography data reception unit that receives first current topography data of a work site detected by a three-dimensional sensor included in each of a plurality of work machines; an attribute data reception unit that receives attribute data given to the first current topography data; a current topography data creation unit that creates second current topography data of the work site on a basis of the first current topography data; a priority storage unit that stores priority related to attribute data given to the second current topography data; and an attribute data update unit that, in a case where a plurality of pieces of attribute data of a certain point of the first current topography data is received within a predetermined time, gives attribute data to the point of the second current topography data on a basis of the priority.

### Advantageous Effects of Invention

According to the present disclosure, a situation of a work site into current topography data can be appropriately incorporated.

### BRIEF DESCRIPTION OF DRAWINGS

FIG. 1 is a diagram schematically illustrating a management system for a work site according to an embodiment.

FIG. 2 is a side view schematically illustrating a work machine according to the embodiment.

FIG. 3 is a plan view schematically illustrating a three-dimensional sensor and an obstacle sensor according to the embodiment.

FIG. 4 is a diagram schematically illustrating an example of operation of the work machine according to the embodiment.

FIG. 5 is a block diagram illustrating a detection system for the work machine according to the embodiment.

FIG. 6 is a diagram for describing stored data stored in a current topography data storage unit according to the embodiment.

FIG. 7 is a diagram for describing priority of attribute data according to the embodiment.

FIG. 8 is a diagram for describing a method of giving attribute data according to the embodiment.

FIG. 9 is a diagram for describing a method of updating attribute data according to the embodiment.

FIG. 10 is a flowchart illustrating a current topography data creation method according to the embodiment.

FIG. 11 is a block diagram illustrating a computer system according to the embodiment.

### DESCRIPTION OF EMBODIMENTS

Hereinafter, embodiments according to the present disclosure will be described with reference to the drawings, but the present disclosure is not limited to the embodiments.

Components of the embodiments described below can be appropriately combined. Furthermore, some components may not be used.

### [Management System]

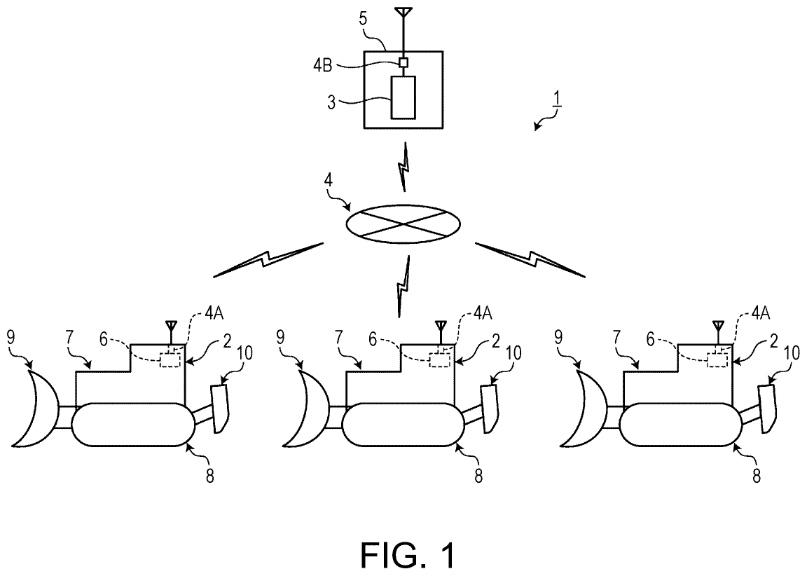

FIG. 1 is a diagram schematically illustrating a management system 1 for a work site according to an embodiment. In the embodiment, the work site is a mine. The mine refers to a place or a business site where minerals are mined. As the mine, a metal mine where metal is mined, a non-metal mine where limestone is mined, and a coal mine where coal is mined are exemplified. A plurality of work machines 2 operates at the work site. In the embodiment, the work machines 2 are bulldozers. The work machines 2 perform predetermined work at the work site. Examples of the work performed by the work machines 2 include excavating work, dozing work, and leveling work.

The management system 1 includes a management device 3 and a communication system 4. The management device 3 includes a computer system. The management device 3 is disposed outside the work machines 2. The management device 3 is installed in a control facility 5 at the work site. The management device 3 manages the work site and the work machines 2. There is an administrator in the control facility 5. Examples of the communication system 4 include the Internet, a mobile phone communication network, a satellite communication network, and a local area network (LAN). Examples of the local area network include Wi-Fi (registered trademark), which is one standard of wireless LAN.

Each of the work machines 2 includes a control device 6 and a wireless communication device 4A. The control device 6 includes a computer system. The wireless communication device 4A is connected to the control device 6. The communication system 4 includes the wireless communication device 4A connected to the control device 6 and a wireless communication device 4B connected to the management device 3. The management device 3 and the control device 6 of the work machine 2 wirelessly communicate with each other via the communication system 4.

### [Work Machine]

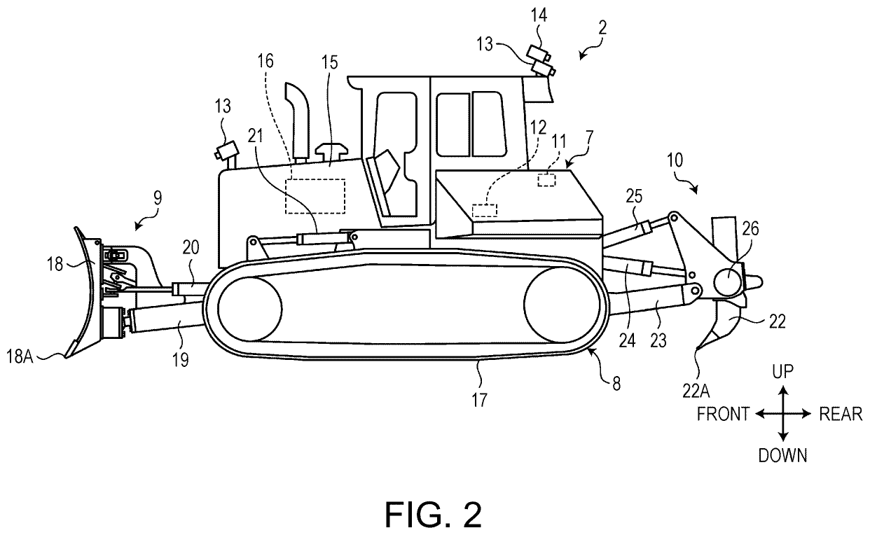

FIG. 2 is a side view schematically illustrating the work machine 2 according to the embodiment. As illustrated in FIG. 2, the work machine 2 includes a vehicle body 7, a traveling device 8, an excavation implement 9, a ripper implement 10, a position sensor 11, an inclination sensor 12, a three-dimensional sensor 13, and an obstacle sensor 14. The vehicle body 7 includes an engine room 15. An engine 16 is housed in the engine room 15. The engine 16 is a driving source of the work machine 2. The traveling device 8 travels while supporting the vehicle body 7. The traveling device 8 includes a pair of crawler belts 17. The work machine 2 travels by rotation of the crawler belts 17.

The excavation implement 9 performs excavating work, dozing work, or leveling work of a work target. The excavation implement 9 is attached to the vehicle body 7. At least a part of the excavation implement 9 is disposed in front of the vehicle body 7. The excavation implement 9 includes an excavation blade 18, a lift frame 19, a tilt cylinder 20, and a lift cylinder 21.

The excavation blade 18 is disposed in front of the vehicle body 7. The excavation blade 18 includes a cutting blade 18A. The lift frame 19 supports the excavation blade 18. One end portion of the lift frame 19 is connected to the back surface of the excavation blade 18 via a rotation mechanism. The other end portion of the lift frame 19 is connected to the vehicle body 7 via a rotation mechanism. Note that the other end portion of the lift frame 19 may be connected to the traveling device 8 via a rotation mechanism.

Each of the tilt cylinder 20 and the lift cylinder 21 operates the excavation blade 18. The tilt cylinder 20 is driven to tilt the excavation blade 18. The lift cylinder 21 is driven to move the excavation blade 18 in the up-and-down direction. One end portion of the tilt cylinder 20 is connected to the back surface of the excavation blade 18 via a rotation mechanism. The other end portion of the tilt cylinder 20 is connected to the upper surface of the lift frame 19. As the tilt cylinder 20 extends and contracts, the tilt angle of the excavation blade 18 changes. One end portion of the lift cylinder 21 is connected to the back surface of the lift frame 19 via a rotation mechanism. The other end portion of the lift cylinder 21 is connected to the vehicle body 7 via a rotation mechanism. The excavation blade 18 moves in the up-and-down direction by extension and contraction of the lift cylinder 21.

The ripper implement 10 performs ripping work including cutting or crushing of a work target. The ripper implement 10 is attached to the vehicle body 7. At least a part of the ripper implement 10 is disposed behind the vehicle body 7. The ripper implement 10 includes a shank 22, a ripper arm 23, a tilt cylinder 24, a lift cylinder 25, and a beam 26. The shank 22 is disposed behind the vehicle body 7. The shank 22 includes a ripper point 22A. The ripper point 22A is included at the tip of the shank 22. The ripper arm 23 supports the shank 22. The ripper arm 23 connects the vehicle body 7 and the shank 22. One end portion of the ripper arm 23 is connected to a rear portion of the vehicle body 7 via a rotation mechanism. The other end portion of the ripper arm 23 is connected to the beam 26. The beam 26 is rotatably connected to the ripper arm 23. The shank 22 is connected to the ripper arm 23 via the beam 26.

Each of the tilt cylinder 24 and the lift cylinder 25 operates the shank 22. Each of the tilt cylinder 24 and the lift cylinder 25 is connected to the vehicle body 7. The tilt cylinder 24 is driven to tilt the shank 22. The lift cylinder 25 is driven to move the shank 22 in the up-and-down direction. One end portion of the tilt cylinder 24 is connected to the beam 26 via a rotation mechanism. The other end portion of the tilt cylinder 24 is connected to the rear portion of the vehicle body 7. The tilt angle of the shank 22 changes by extension and contraction of the tilt cylinder 24. The tilt cylinder 24 moves the shank 22 in the front-and-rear direction. One end portion of the lift cylinder 25 is connected to the beam 26 via a rotation mechanism. The other end portion of the lift cylinder 25 is connected to the rear portion of the vehicle body 7. The shank 22 moves in the up-and-down direction by extension and contraction of the lift cylinder 25. The lift cylinder 25 moves the shank 22 in the up-and-down direction.

The ripper implement 10 pierces a work target with the ripper point 22A. The work target is cut or crushed by the traveling device 8 traveling in a state where the work target is pierced with the ripper point 22A. While the traveling device 8 is traveling, the shank 22 may be moved in the up-and-down direction and the front-and-rear direction.

The position sensor 11 detects the position of the work machine 2. The position of the work machine 2 is detected using a global navigation satellite system (GNSS). The global navigation satellite system includes a global positioning system (GPS). The global navigation satellite system detects a position in a global coordinate system defined by coordinate data of latitude, longitude, and altitude. The global coordinate system refers to a coordinate system fixed to the earth. The position sensor 11 includes a GNSS receiver. The position sensor 11 detects the position of the work machine 2 in the global coordinate system. The position sensor 11 is disposed on the vehicle body 7.

The inclination sensor 12 detects the inclination of the vehicle body 7. The inclination sensor 12 detects an inclination angle of the vehicle body 7 with respect to the horizontal plane. The inclination sensor 12 includes an inertial measurement unit (IMU). The inclination sensor 12 is disposed on the vehicle body 7.

The three-dimensional sensor 13 detects a three-dimensional shape of a detection target. The three-dimensional sensor 13 detects the three-dimensional shape of the detection target in a non-contact manner with the detection target. The detection target of the three-dimensional sensor 13 includes a work site. The three-dimensional sensor 13 detects a three-dimensional shape of the work site. The three-dimensional shape of the work site includes the topography of the work site. The three-dimensional sensor 13 detects a distance to the surface of the detection target. The three-dimensional sensor 13 detects the three-dimensional shape of the surface of the detection target by detecting the relative distance of each of a plurality of detection points on the surface of the detection target. The three-dimensional data indicating the three-dimensional shape of the detection target includes point cloud data including a plurality of detection points. The three-dimensional data includes the relative distance and the relative position between the three-dimensional sensor 13 and each of the plurality of detection points defined in the detection target. The three-dimensional data includes height data of each of the plurality of detection points. Examples of the three-dimensional sensor 13 include a laser sensor (light detection and ranging (LIDAR)) that detects a detection target by emitting laser light. Note that the three-dimensional sensor 13 may be a three-dimensional camera such as a stereo camera. The three-dimensional sensor 13 is disposed on the vehicle body 7.

The obstacle sensor 14 detects an obstacle of the work machine 2 that exists at the work site. The obstacle sensor 14 detects an obstacle in a non-contact manner with the obstacle. Examples of the obstacle sensor 14 include a radar sensor (radio detection and ranging (RADAR)) that detects an obstacle by emitting radio waves. Note that the obstacle sensor 14 may be an infrared sensor that detects an obstacle by emitting infrared light. The obstacle sensor 14 is disposed on the vehicle body 7.

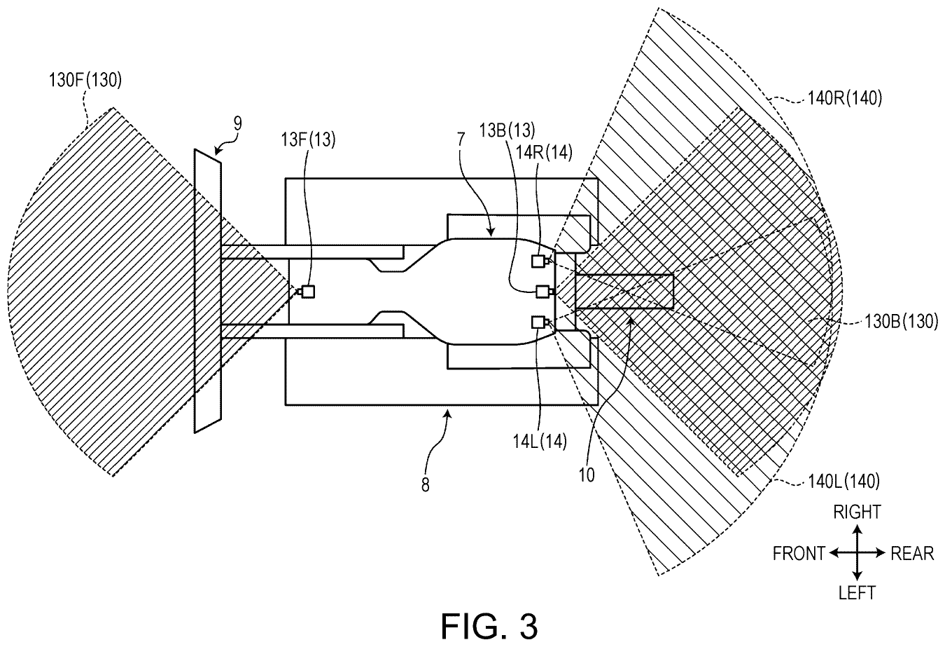

FIG. 3 is a plan view schematically illustrating the three-dimensional sensor 13 and the obstacle sensor 14 according to the embodiment. As illustrated in FIG. 3, the three-dimensional sensor 13 includes a detection range 130. The three-dimensional sensor 13 detects three-dimensional data of a detection target disposed in the detection range 130. In the embodiment, the three-dimensional sensor 13 includes a three-dimensional sensor 13F that detects three-dimensional data in front of the vehicle body 7 and a three-dimensional sensor 13B that detects three-dimensional data behind the vehicle body 7. The detection range 130 of the three-dimensional sensor 13 includes a detection range 130F of the three-dimensional sensor 13F and a detection range 130B of the three-dimensional sensor 13B. At least a part of the detection range 130F is defined in front of the excavation implement 9. At least a part of the detection range 130B is defined behind the ripper implement 10.

As illustrated in FIG. 3, the obstacle sensor 14 includes a detection range 140. The obstacle sensor 14 detects an obstacle disposed in the detection range 140. In the embodiment, the obstacle sensor 14 detects an obstacle behind the vehicle body 7. The obstacle sensor 14 includes an obstacle sensor 14L disposed on the left side of the center of the vehicle body 7 in the left-and-right direction and an obstacle sensor 14R disposed on the right side. The detection range 140 of the obstacle sensor 14 includes a detection range 140L of the obstacle sensor 14L and a detection range 140R of the obstacle sensor 14R. At least a part of the detection range 140L and at least a part of the detection range 140R are defined behind the vehicle body 7. At least a part of the detection range 140L is defined on the left side of the vehicle body 7. At least a part of the detection range 140R is defined on the right side of the vehicle body 7.

### [Operation of Work Machine]

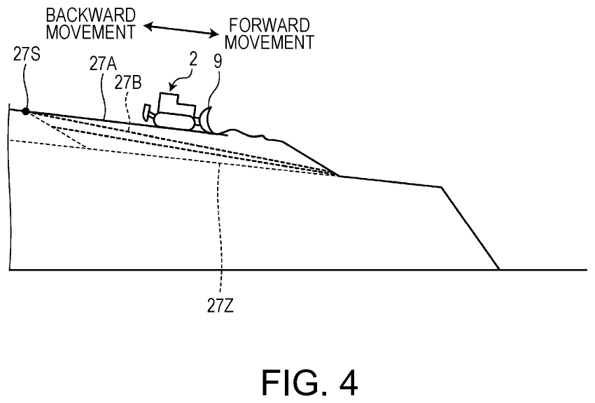

FIG. 4 is a diagram schematically illustrating an example of operation of the work machine 2 according to the embodiment. In the embodiment, the work machine 2 can perform slot dozing. The slot dozing refers to a construction method in which the work machine 2 excavates a work target while repeating forward movement and backward movement along a slot-shaped excavation lane formed in the work target. In the embodiment, the work machine 2 performs slot dozing by automatic control. As illustrated in FIG. 4, the work machine 2 performs slot dozing such that the current topography has a shape along a final design surface 27Z. In the example illustrated in FIG. 4, in the first excavation, the work machine 2 excavates a work target using the excavation implement 9 while moving forward from an excavation start point 27S so that the current topography has a shape along a first intermediate design surface 27A. After the first excavation is completed, the work machine 2 moves backward so as to return to the excavation start point 27S. In the second excavation, the work machine 2 excavates the work target using the excavation implement 9 while moving forward from the excavation start point 27S so that the current topography has a shape along a second intermediate design surface 27B. The work machine 2 repeats forward movement and backward movement until the current topography has a shape along the final design surface 27Z.

Note that the automatic control of the work machine 2 may be semi-automatic control performed in conjunction with manual operation by an operator, or may be full-automatic control performed without manual operation. In a case of the semi-automatic control, an operation device for manual operation may be mounted on the work machine 2 and subjected to boarding operation by an operator who rides on the work machine 2. An operation device for manual operation may be disposed outside the work machine 2 and remotely operated by an operator who exists outside the work machine 2.

### [Current Topography Data Creation System]

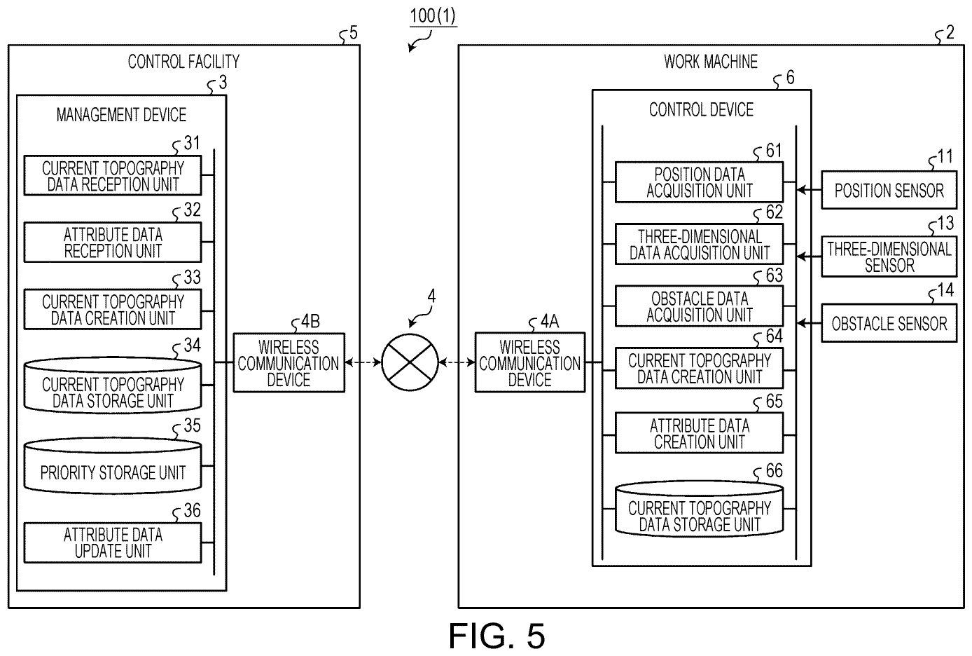

FIG. 5 is a block diagram illustrating a current topography data creation system 100 of the work machine 2 according to the embodiment. The management system 1 includes the current topography data creation system 100. The current topography data creation system 100 creates current topography data of a work site. The current topography data creation system 100 includes the control device 6, the position sensor 11, the three-dimensional sensor 13, the obstacle sensor 14, and the management device 3. The control device 6 includes a position data acquisition unit 61, a three-dimensional data acquisition unit 62, an obstacle data acquisition unit 63, a current topography data creation unit 64, an attribute data creation unit 65, and a current topography data storage unit 66.

The position data acquisition unit 61 acquires position data indicating the current position of the work machine 2. The current position of the work machine 2 includes detection data of the position sensor 11. The position data acquisition unit 61 acquires detection data of the position sensor 11 as position data. The position data acquisition unit 61 acquires posture data indicating the posture of the work machine 2. The posture of the work machine 2 includes detection data of the inclination sensor 12. The position data acquisition unit 61 acquires detection data of the inclination sensor 12 as the posture data.

The three-dimensional data acquisition unit 62 acquires three-dimensional data indicating a three-dimensional shape of a work site where the work machine 2 operates. The three-dimensional data of the work site includes detection data of the three-dimensional sensor 13. The three-dimensional data acquisition unit 62 acquires detection data of the three-dimensional sensor 13 as three-dimensional data.

The obstacle data acquisition unit 63 acquires obstacle data indicating an obstacle that exists at the work site. The obstacle data acquisition unit 63 acquires obstacle data indicating an obstacle that exists around the work machine 2. The obstacle data includes detection data of the obstacle sensor 14. The obstacle data acquisition unit 63 acquires detection data of the obstacle sensor 14 as the obstacle data. The obstacle data may include three-dimensional data indicating a three-dimensional shape of a detection target of the three-dimensional sensor 13. The obstacle data acquisition unit 63 may acquire, as the obstacle data, a position obtained by integrating representative points of a standing object detected from point cloud data included in the three-dimensional data and detection data of the obstacle sensor 14.

The current topography data creation unit 64 creates first current topography data of the work site on the basis of the three-dimensional data acquired by the three-dimensional data acquisition unit 62, the position data indicating the current position of the work machine 2 acquired by the position data acquisition unit 61, and the posture data indicating the posture of the work machine 2. The current topography data creation unit 64 creates the first current topography data of the work site on the basis of the detection data of the three-dimensional sensor 13, the detection data of the position sensor 11, and the detection data of the inclination sensor 12. The attribute data creation unit 65 creates attribute data given to the first current topography data. The current topography data storage unit 66 stores the first current topography data of the work site created by the current topography data creation unit 64. The current topography data storage unit 66 stores the first current topography data and the attribute data in association with each other.

The current topography data reception unit 31 receives the first current topography data of the work site from each of the plurality of work machines 2. The current topography data reception unit 31 receives the first current topography data of the work site from the current topography data storage unit 66 via the communication system 4. As described above, a plurality of work machines 2 exists at the work site. Each of the plurality of work machines 2 transmits the first current topography data stored in the current topography data storage unit 66 to the management device 3 via the communication system 4. The current topography data reception unit 31 receives the first current topography data transmitted from each of the plurality of work machines 2.

An attribute data reception unit 32 receives the attribute data given to the first current topography data. The attribute data reception unit 32 receives the attribute data given to the first current topography data from the current topography data storage unit 66 via the communication system 4.

The current topography data creation unit 33 creates second current topography data of the work site on the basis of the first current topography data received by the current topography data reception unit 31. The current topography data creation unit 33 integrates the first current topography data transmitted from each of the plurality of work machines 2 to create the second current topography data of the work site. The current topography data storage unit 34 stores the second current topography data created by the current topography data creation unit 33. Each of the plurality of work machines 2 transmits the first current topography data to the management device 3 at predetermined time intervals. Each of the plurality of work machines 2 transmits the first current topography data to the management device 3, for example, every second. The current topography data creation unit 33 creates the second current topography data each time the first current topography data is received. In order for the current topography data creation unit 33 to create the first current topography data, the second current topography data stored in the current topography data storage unit 34 is updated.

A priority storage unit 35 stores priority related to the attribute data given to the second current topography data. In a case where a plurality of pieces of attribute data of a certain point of the first current topography data is received within a predetermined time, an attribute data update unit 36 gives the attribute data to a point of the second current topography data on the basis of the priority. The predetermined time is, for example, 10 minutes.

### [Stored Data]

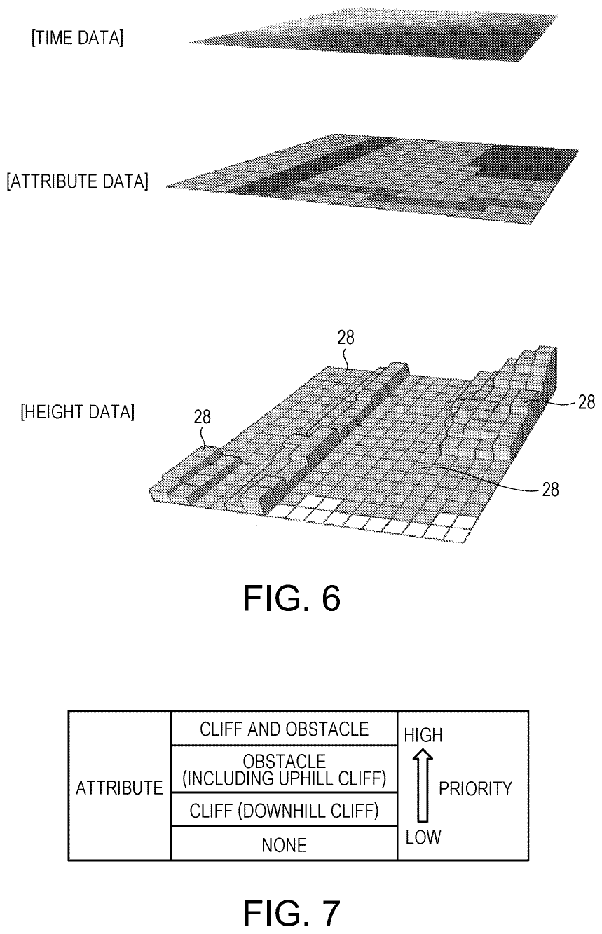

FIG. 6 is a diagram for describing stored data stored in the current topography data storage unit 66 according to the embodiment. As illustrated in FIG. 6, three-dimensional data of a work site includes height data of each of a plurality of detection points 28 defined on the surface of the topography of the work site. The position of each of the plurality of detection points 28 in the global coordinate system is determined on the basis of the current position of the work machine 2 when the three-dimensional data is acquired, the posture of the work machine 2, and the three-dimensional data. Note that the positions of the detection points 28 may be defined in the global coordinate system or may be defined in a predetermined coordinate system such as a local coordinate system set in the work machine 2. Time data indicating time is given to each of the plurality of detection points 28. The time indicated by the time data refers to the time when the three-dimensional data acquisition unit 62 acquires the detection point 28 or the time when the position data acquisition unit 61 acquires position data corresponding to the detection point 28. Note that the time of the time data may be regarded as the time when the three-dimensional sensor 13 detects the detection point 28. The time data is stored in association with each of the plurality of detection points 28. Further, attribute data indicating an attribute is given to each of the plurality of detection points 28. The attribute indicated by the attribute data refers to an attribute of the detection point 28. The attribute of the detection point 28 includes an attribute related to the topography of the work site and an attribute related to an obstacle that exists at the work site. The attribute data is stored in association with each of the plurality of detection points 28.

### [Priority of Attribute Data]

FIG. 7 is a diagram for describing priority of the attribute data according to the embodiment. The attribute indicated by the attribute data includes an attribute related to the topography of the work site and an attribute related to an obstacle that exists at the work site. The attribute includes a first attribute indicating that a certain point (detection point 28) of the topography data is a cliff, a second attribute indicating that an obstacle exists at the point, a third attribute indicating that the point is a cliff and an obstacle exists at the point, and a zero-th attribute indicating that a cliff and an obstacle do not exist. The priority of the third attribute is the highest, the priority of the second attribute is the highest after the third attribute, the priority of the first attribute is the highest after the second attribute, and the priority of the zero-th attribute is the lowest.

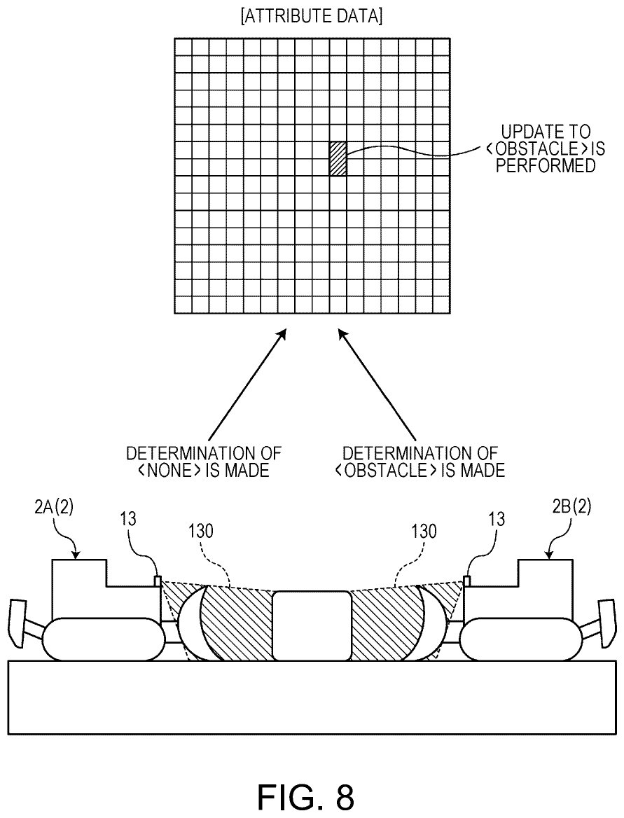

FIG. 8 is a diagram for describing a method of giving the attribute data according to the embodiment. In a case where a plurality of pieces of attribute data is received by the attribute data reception unit 32, the attribute data update unit 36 determines whether the attribute data received by the attribute data reception unit 32 is attribute data transmitted from each of the plurality of different work machines 2 or attribute data transmitted from the same work machine 2. Identification data (vehicle ID) of the work machine 2 is given to the attribute data transmitted from the work machine 2 to the management device 3. The attribute data update unit 36 can determine whether the attribute data received by the attribute data reception unit 32 is attribute data transmitted from each of the plurality of different work machines 2 or attribute data transmitted from the same work machine 2 on the basis of the vehicle ID.

As illustrated in FIG. 8, for example, one detection target may be detected by a plurality of three-dimensional sensors 13 or obstacle sensors 14 different from each other. FIG. 8 illustrates a state in which a detection target is detected by a plurality of different work machines 2. That is, a state is illustrated in which one point (detection target) is detected by the three-dimensional sensor 13 mounted on a first work machine 2A and the three-dimensional sensor 13 mounted on a second work machine 2B. There is a possibility that the attribute data given to a point (detection point 28) by the attribute data creation unit 65 of the first work machine 2A is different from the attribute data given to a point (detection point 28) by the attribute data creation unit 65 of the second work machine 2B. In the example illustrated in FIG. 8, the attribute data creation unit 65 of the first work machine 2A determines that a cliff and an obstacle do not exist at a point on the basis of the detection data of the three-dimensional sensor 13. That is, the attribute data creation unit 65 of the first work machine 2A gives the zero-th attribute to the point (detection point 28). On the other hand, the attribute data creation unit 65 of the second work machine 2B determines that an obstacle exists at the point on the basis of the detection data of the three-dimensional sensor 13. That is, the attribute data creation unit 65 of the second work machine 2B gives the first attribute to the point (detection point 28). In a case where both zero-th attribute data and first attribute data having higher priority than the zero-th attribute data are received by the attribute data reception unit 32 within a predetermined time, the attribute data update unit 36 gives the first attribute data to the point of the second current topography data.

### [Method for Updating Attribute Data]

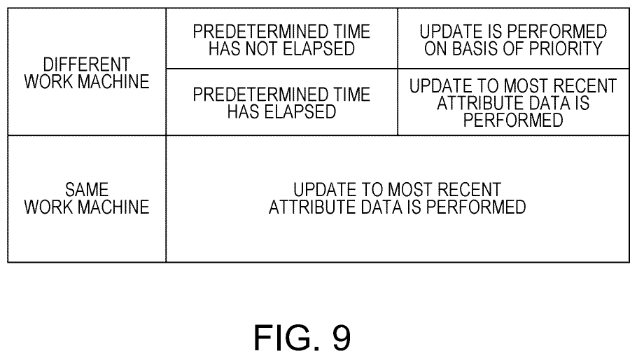

FIG. 9 is a diagram for describing a method of updating the attribute data according to the embodiment. As described with reference to FIG. 8, in a case where the attribute data reception unit 32 receives the attribute data transmitted from each of the plurality of work machines 2 different from each other, the attribute data update unit 36 gives the attribute data having high priority to the second current topography data. That is, the attribute data update unit 36 updates the attribute data given to the second current topography data on the basis of the priority.

In a case where the attribute data reception unit 32 receives the attribute data transmitted from each of the plurality of work machines 2 different from each other, if a predetermined time has elapsed from the most recent time point at which the attribute data is updated, the attribute data update unit 36 updates the attribute data given to the second current topography data to the most recent attribute data received after the lapse of the predetermined time regardless of the priority.

In a case where the attribute data reception unit 32 receives the attribute data transmitted from the same work machine 2, the attribute data update unit 36 updates the attribute data given to the second current topography data to the most recent attribute data regardless of the priority.

For example, in a case where the predetermined time is set to 10, if the attribute data reception unit 32 receives [none] that is the zero-th attribute data from the work machine 2A at a time point t1, the attribute data update unit 36 gives [none] to the point of the second current topography data. If [obstacle] that is the first attribute data is received from the work machine 2B at a time point t2, the [obstacle] has higher priority than [none] received at the time point t1 and is transmitted from the work machine 2B different from the work machine 2A that has transmitted the attribute data at the time point t1, and thus, update from [none] to [obstacle] is performed on the basis of the priority. If [none] is received from the work machine 2A at a time point t3, the [none] has lower priority, the predetermined time has not elapsed from the time point t2, and the [none] is transmitted from the work machine 2A different from the work machine 2B that has transmitted the attribute data at the time point t2, and thus, [obstacle] is held. If [obstacle] is received from the work machine 2B at a time point t4, [obstacle] is held. If [none] is received from the work machine 2B at a time point t5, although the [none] has lower priority and the predetermined time has not elapsed, the [none] is transmitted from the work machine 2B same as the work machine 2B that has transmitted the attribute data at the time point t4, and thus, update from [obstacle] to [none] is immediately performed regardless of the priority. If [obstacle] is received from the work machine 2A at a time point t6, the [obstacle] is transmitted from the work machine 2A different from the work machine 2B that has transmitted the attribute data at the time point t5, and thus, update from [none] to [obstacle] is performed on the basis of the priority. If [none] is received from the work machine 2B at a time point t7, the [none] has lower priority, the predetermined time has not elapsed from the time point t6, and the [none] is transmitted from the work machine 2B different from the work machine 2A that has transmitted the attribute data at the time point t6, and thus, [obstacle] is held. If [none] is received from the work machine 2B at a time point t18, the predetermined time has elapsed from the time point t7, and thus, update from [obstacle] to [none] is immediately performed regardless of the priority.

### [Current Topography Data Creation Method]

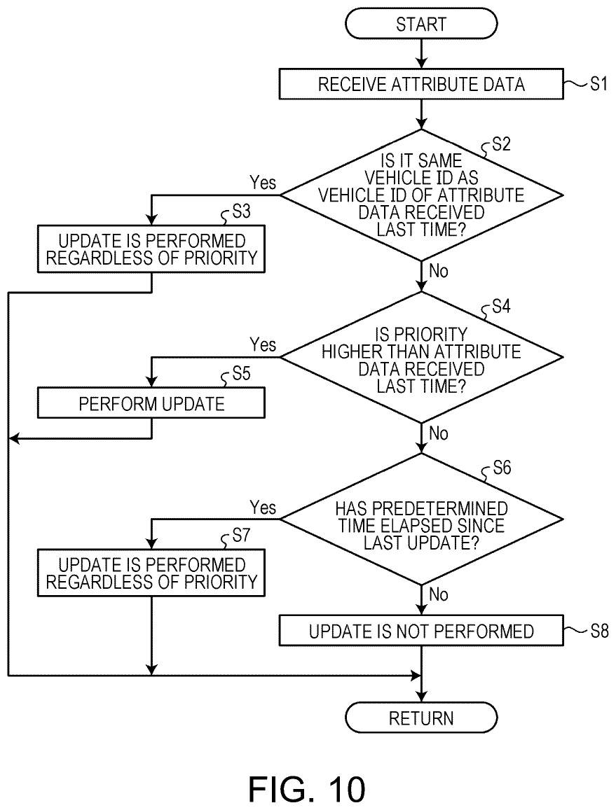

FIG. 10 is a flowchart illustrating a current topography data creation method according to the embodiment. The attribute data reception unit 32 receives the attribute data from the work machine 2 (step S1). The attribute data reception unit 32 determines whether the vehicle ID given to the attribute data received in step S1 is the same as the vehicle ID of the attribute data received last time (step S2). If it is determined in step S2 that the vehicle IDs are the same (step S2: Yes), the attribute data update unit 36 updates the attribute data given to the point of the second current topography data to the attribute data received in step S1 regardless of the priority (step S3).

If it is determined in step S2 that the vehicle IDs are not the same (step S2: No), the attribute data update unit 36 determines whether the priority of the attribute data received in step S1 is higher than the priority of the attribute data received last time (step S4). If it is determined in step S4 that the priority of the attribute data received in step S1 is high (step S4: Yes), the attribute data update unit 36 updates the attribute data given to the point of the second current topography data to the attribute data received in step S1 on the basis of the priority (step S5).

If it is determined in step S4 that the priority of the attribute data received in step S1 is low (step S4: No), the attribute data update unit 36 determines whether a predetermined time has elapsed since the time point at which the attribute data given to the point of the second current topography data has been updated last time (step S6). If it is determined in step S6 that the predetermined time has elapsed since the time point at which the attribute data has been updated last time (step S6: Yes), the attribute data update unit 36 updates the attribute data given to the point of the second current topography data to the attribute data received in step S1 regardless of the priority (step S7).

If it is determined in step S6 that the predetermined time has not elapsed since the time point at which the attribute data has been updated last time (step S6: No), the attribute data update unit 36 does not update the attribute data given to the point of the second current topography data (step S8).

### [Computer System]

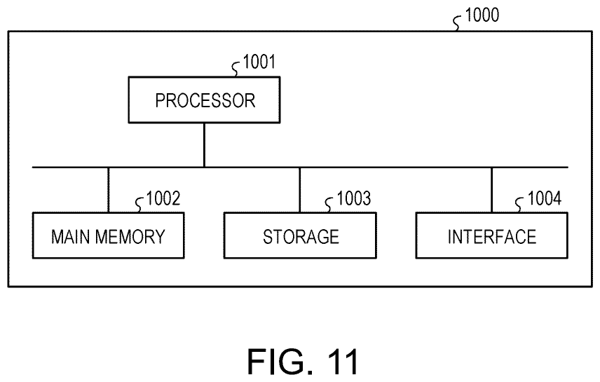

FIG. 11 is a block diagram illustrating a computer system 1000 according to the embodiment. Each of the management device 3 and the control device 6 described above includes a computer system 1000. The computer system 1000 includes a processor 1001 such as a central processing unit (CPU), a main memory 1002 including a nonvolatile memory such as a read only memory (ROM) and a volatile memory such as a random access memory (RAM), a storage 1003, and an interface 1004 including an input/output circuit. The functions of the management device 3 and the control device 6 described above are stored in the storage 1003 as a computer program. The processor 1001 reads the computer program from the storage 1003, develops the computer program in the main memory 1002, and executes the above-described processing according to the program. Note that the computer program may be distributed to the computer system 1000 via a network.

According to the above-described embodiment, the computer system 1000 or the computer program can execute: receiving first current topography data of a work site from each of a plurality of work machines 2; receiving attribute data given to the first current topography data; creating second current topography data of the work site on the basis of the first current topography data; storing priority related to attribute data given to the second current topography data; and in a case where a plurality of pieces of attribute data of a certain point of the first current topography data is received within a predetermined time, giving attribute data to the point of the second current topography data on the basis of the priority.

### [Effects]

As described above, the current topography data creation system 100 for a work site according to the embodiment includes: the current topography data reception unit 31 that receives first current topography data of a work site from each of the plurality of work machines 2; the attribute data reception unit 32 that receives attribute data given to the first current topography data; the current topography data creation unit 33 that creates second current topography data of the work site on the basis of the first current topography data; the priority storage unit 35 that stores priority related to attribute data given to the second current topography data; and the attribute data update unit 36 that, in a case where a plurality of pieces of attribute data of a certain point of the first current topography data is received within a predetermined time, gives attribute data to the point of the second current topography data on the basis of the priority. In a case where a plurality of pieces of attribute data of the same point (detection point 28) received within a predetermined period is different from each other, the attribute data update unit 36 gives the attribute data to the point of the second current topography data on the basis of the priority. Since attribute data having high priority is given to the point of the second current topography data, appropriate attribute data is incorporated into the second current topography data. In a case where attribute data having high priority and attribute data having low priority are alternately received, for example, the attribute data update unit 36 needs to update attribute data with high frequency. In a case where a plurality of pieces of attribute data at the same point received within a predetermined period is different from each other, attribute data having high priority is held, and thus, the attribute data update unit 36 does not need to update attribute data with high frequency. Further, in a case where a state in which certain attribute data is received exceeds a predetermined time, even if the priority of the attribute data is low, the attribute data is incorporated into the second current topography data. In a case where a state in which certain attribute data is received exceeds a predetermined time, it is considered that the attribute data represents a true situation of a work site. In a case where a state in which certain attribute data is received exceeds a predetermined time, the attribute data is incorporated into the second current topography data, so appropriate current topography data (second current topography data) is created.

### OTHER EMBODIMENTS

In the above-described embodiment, the current topography data creation unit 64 may create the current topography data of a work site on the basis of at least the three-dimensional data acquired by the three-dimensional data acquisition unit 62. Further, the current topography data creation unit 64 may create the current topography data of a work site on the basis of at least the position data indicating the current position of the work machine 2 acquired by the position data acquisition unit 61.

In the above-described embodiment, at least a part of the functions of the control device 6 may be included in the management device 3. At least a part of the functions of the management device 3 may be included in the control device 6.

In the above-described embodiment, for example, each of the position data acquisition unit 61, the three-dimensional data acquisition unit 62, the obstacle data acquisition unit 63, the current topography data creation unit 64, the attribute data creation unit 65, and the current topography data storage unit 66 may be formed by different hardware.

In the above-described embodiment, the work machines 2 are bulldozers. The work machines 2 may be other work machines such as excavators, wheel loaders, or motor graders.

Reference Signs List

| | |
|---|---|
| 1 | Management system |
| 2 | Work machine |
| 3 | Management device |
| 4 | Communication system |
| 4A | Wireless communication device |
| 4B | Wireless communication device |
| 5 | Control facility |
| 6 | Control device |
| 7 | Vehicle body |
| 8 | Traveling device |
| 9 | Excavation implement |
| 10 | Ripper implement |
| 11 | Position sensor |
| 12 | Inclination sensor |
| 13 | Three-dimensional sensor |
| 13F | Three-dimensional sensor |
| 13B | Three-dimensional sensor |
| 14 | Obstacle sensor |
| 14L | Obstacle sensor |
| 14R | Obstacle sensor |
| 15 | Engine room |
| 16 | Engine |
| 17 | Crawler belt |
| 18 | Excavation blade |
| 18A | Cutting blade |
| 19 | Lift frame |
| 20 | Tilt cylinder |
| 21 | Lift cylinder |
| 22 | Shank |
| 22A | Ripper point |
| 23 | Ripper arm |
| 24 | Tilt cylinder |
| 25 | Lift cylinder |
| 26 | Beam |
| 27A | First intermediate design surface |
| 27B | Second intermediate design surface |
| 27S | Excavation start point |
| 27Z | Final design surface |
| 28 | Detection point |
| 31 | Current topography data reception unit |
| 32 | Attribute data reception unit |
| 33 | Current topography data creation unit |
| 34 | Current topography data storage unit |
| 35 | Priority storage unit |
| 36 | Attribute data update unit |
| 61 | Position data acquisition unit |
| 62 | Three-dimensional data acquisition unit |
| 63 | Obstacle data acquisition unit |
| 64 | Current topography data creation unit |
| 65 | Attribute data creation unit |
| 66 | Current topography data storage unit |
| 100 | Current topography data creation system |
| 130 | Detection range |
| 130F | Detection range |
| 130B | Detection range |
| 140 | Detection range |
| 140L | Detection range |
| 140R | Detection range |
| 1000 | Computer system |
| 1001 | Processor |
| 1002 | Main memory |
| 1003 | Storage |
| 1004 | Interface |

1. A current topography data creation system for a work site, the current topography data creation system comprising:
a hardware processor configured to:
receive first current topography data of a work site detected by a three-dimensional sensor included in each of a plurality of work machines;
receive attribute data given to the first current topography data;
create second current topography data of the work site on a basis of the first current topography data;
store priority related to attribute data given to the second current topography data; and
in a case where a plurality of pieces of attribute data of a certain point of the first current topography data is received within a predetermined time, give attribute data to the point of the second current topography data on a basis of the priority.

2. The current topography data creation system for a work site according to claim 1,
wherein attribute data includes first attribute data and second attribute data having higher priority than the first attribute data, and
in a case where both the first attribute data and the second attribute data are received within a predetermined time, the attribute data update unit gives the second attribute data to the point of the second current topography data.

3. The current topography data creation system for a work site according to claim 2,
wherein in a case where the first attribute data is received after a lapse of a predetermined time from a time point at which attribute data is updated last time, the attribute data update unit gives the first attribute data to the point of the second current topography data.

4. The current topography data creation system for a work site according to claim 1,
wherein an attribute indicated by the attribute data includes an attribute related to topography of the work site and an attribute related to an obstacle that exists at the work site.

5. The current topography data creation system for a work site according to claim 4,
wherein the attribute includes a first attribute indicating that the point is a cliff, a second attribute indicating that an obstacle exists at the point, and a third attribute indicating that the point is a cliff and an obstacle exists at the point, and
priority of the second attribute is the highest after the third attribute, and priority of the first attribute is the highest after the second attribute.

6. A current topography data creation method for a work site, the current topography data creation method comprising:
receiving first current topography data of a work site from each of a plurality of work machines;
receiving attribute data given to the first current topography data;
creating second current topography data of the work site on a basis of the first current topography data;
storing priority related to attribute data given to the second current topography data; and
in a case where a plurality of pieces of attribute data of a certain point of the first current topography data is received within a predetermined time, giving attribute data to the point of the second current topography data on a basis of the priority.
